(19) United States
(12) Patent Application Publication
(10) Pub. No.: US 2026/0208053 A1
(43) Pub. Date: Jul. 23, 2026

(54) SMART INTERACTIVE COMPOSITE DEVICE

(71) Applicant: Szu Cheng MA, Taoyuan City (TW)

(72) Inventor: Huan Pien LI, Taoyuan City (TW)

(73) Assignee: Szu Cheng MA, Taoyuan City (TW)

(21) Appl. No.: 19/028,600

(22) Filed: Jan. 17, 2025

(51) Int. Cl. A63F 13/803; A63F 13/245; B25J 9/00; B62D 57/028; B62D 57/032; G02B 27/01

(52) U.S. Cl. CPC A63F 13/803; A63F 13/245; B25J 9/0009; B62D 57/028; B62D 57/032; G02B 27/017; G02B 2027/0178

(57) ABSTRACT

A smart interactive composite device, having a motion platform combining on a XYθ axis moving platform, and further combining with a smart helmet and VR glasses to form a 4D immersive interactive game car, which allows users to obtain a better operating experience in a virtual reality motion environment, makes the game character vivid and distinctive, and allows players to obtain a deeper immersive experience and enhance the virtual reality, fun and entertainment of the game.

### BACKGROUND OF THE INVENTION

### 1. Field of the Invention

A smart interactive composite device, especially to one that has a motion platform combining on a XYθ axis moving platform, and further combining with a smart helmet and VR glasses to form a 4D immersive interactive game car.

### 2. Description of the Related Art

With the continuous development of technology and the rapid change of the gaming field, various simulation game consoles have been developed, simulated driving cars are one of the many game consoles.

China patent No. CN105999695A discloses a simulated driving game car somatosensory drive simulating system. The somatosensory drive simulating system comprises a chassis supporting frame, a car somatosensory drive simulating system body and a seat system; the car somatosensory drive simulating system body is fixedly connected to the chassis supporting frame, and the seat system is arranged on the somatosensory drive simulating system body; the car somatosensory drive simulating system body is used for driving the seat system to complete simulating actions of a car; the somatosensory drive simulating system body specifically comprises a plurality of drive unit devices; each drive unit device comprises a drive motor, a speed reducer, a rotary shaft, an L-shaped swing rod and a drive rod. The simulated driving game car somatosensory drive simulating system has various technological advantages, and therefore good market prospects and economic benefits are inevitably brought.

China patent No. CN211462044U discloses a VR dynamic simulation driving game car. The VR dynamic simulation driving game car comprises a base, a host, a driving mechanism and a seat, wherein the main machine, the driving mechanism and the seat are all installed on the base, the seat is mechanically connected with the driving mechanism, the driving mechanism drives the seat to rotate, the driving mechanism is in communication connection with the main machine, and the main machine controls the driving mechanism to be opened and closed. The VR dynamic simulation driving game car is accurate in transmission and high in use safety coefficient.

China patent No. CN221637314U discloses a VR dynamic driving simulation game car in the related technical field of game equipment, which comprises a base and a driving chair, one side of the base is provided with a rotating motor, the base is provided with a bridge, the bridge is fixedly connected with an electric control box, the other side of the electric control box is provided with a vibration seat, and the vibration seat is provided with a motor. The driving chair is arranged on the other side of the vibration seat, two rotating frames are arranged at one end of the driving chair, and the other ends of the rotating frames are connected with a backrest. According to the utility model, through the design of the vibration seat and the vibration cylinder, the impact condition generated during the collision of a vehicle can be simulated, the more regional reality is realized, the user experience is greatly improved, the practicability is stronger, and through the design of the first guide rail pair, the safety belt and the adjusting handle, the safety belt can be fixed for a player, and the user is prevented from falling off; meanwhile, the table, the chair and the backrest can be adjusted, the application range is wide, and practicability and economical efficiency are good.

In summary, how to design a driving analog system with the above-mentioned analog functions of “real vehicle simulation actions and vehicle tactile feedback simulation actions” is a technical problem that technicians in this field urge to solve.

Currently, users wear VisionPro® devices, and cloud games are run in window mode on the VisionPro® devices, that is, the game screen is displayed flat in a specific window, thereby achieving the effect of playing cloud games through the headset display device. However, running cloud games on VisionPro® devices relies on the window and cannot be run at any point in full screen. As a result, users cannot experience the immersive window-out effect when playing cloud games on VisionPro® devices.

### SUMMARY OF THE INVENTION

A primary objective of the present invention is to provide a smart interactive composite device, having a motion platform combining on a XYθ axis moving platform, and further combining with a smart helmet and VR glasses to form a 4D immersive interactive game car, which allows users to obtain a better operating experience in a virtual reality motion environment, makes the game character vivid and distinctive, and allows players to obtain a deeper immersive experience and enhance the virtual reality, fun and entertainment of the game.

In order to achieve the above objective, the present invention includes:
a). a motion platform with a seat arranged on the motion platform, and both sides of the seat are connected to two parallel and symmetrical support frames; the support frames are provided with a lighting at the front and rear ends, the lateral sides are respectively provided with a thigh member, and the bottom end of the thigh member pivot to a calf member, wherein the upper end of the thigh member pivot to the support frame through a rotating shaft, and the rotating shaft is driven by a motor provided in the supporting frames, so that the thigh member can swing forward or backward with the rotating shaft as the axis; wherein the upper end of the calf member pivot to the bottom end of the thigh member with a pivot, the calf member forms a convex lug above the pivot, the convex lug is driven by an oil cylinder arranged inside the thigh member, making the calf member able to swing forward or backward with the pivot as the axis; accordingly, the thigh member and the calf members form a body similar to a four legs animal; four sets of connecting devices are respectively arranged at the bottom of the calf members; a plurality of radar sensors, arranged on the support frame, the thigh member and the calf members; a controller, arranged on the seat, having a first wireless transmission module; a joystick, electrically connected to the controller to control the respective movements of the motor and oil cylinder to make the motion platform to lift and decline, move forward and backward, and tilt left and right;
b). a XYθ axis moving platform, includes
   a base seat, arranged with two parallel first tracks and a first linear guide longitudinally provided on the upper surface of the base seat; a longitudinal slide board, arranged on the base seat, and its bottom surface is provided with two parallel first slide grooves relative to the first tracks, and is provided with a first groove relative to the first linear guide to be combined with the first linear guide for driving the longitudinal slide board to move forward and backward (in X axis); in addition, two parallel second tracks and a second linear guide are transversely provided on the upper surface of the longitudinal slide board; a transverse slide board, arranged on the longitudinal slide board, and its bottom surface is provided with two parallel second slide grooves relative to the second tracks, and is provided with a second groove relative to the second linear guide to be combined with the second linear guide for driving the transverse slide board to move left and right (in Y axis); in addition, and the upper surface of the transverse slide board is provided with a circular groove; a disc type motor, arranged on the circular groove; a rotating board, combined to the disc type motor, and its bottom surface does not contact the upper surface of the transverse slide board, making the disc type motor able to drive the rotating board to rotate (θ); the top surface of the XYθ axis moving platform allows the motion platform to be placed on and is electrically connected to the controller to form a multi-dimensional state in which the motion changes of the motion platform are combined with the XYθ axis moving platform;
c). a smart helmet, having a case with a microprocessor inside, the microprocessor is respectively electrically connected to a GPS module, a memory device, a power module and a second wireless transmission module, and a camera and a radar sensor arranged on the case and electrically connected to the microprocessor, and at least one speaker is arranged on two sides of the case;
d). a VR glasses, having a headset, a glasses frame connected to the headset, a transparent display screen installed in the glasses frame, and a microprocessor installed in the glasses frame, the microprocessor is respectively electrically connected to a gyroscope, a memory device, a power module, a third wireless transmission module and a camera; and
   through the controller, making the first wireless transmission module forms a communication connection with the second wireless transmission module and the third wireless transmission module, so that the motion platform, the XYθ axis moving platform, the smart helmet and the VR glasses have an interactive relationship, forming a 4D immersive interactive game car.

Also, the present invention further includes: an AI composite clothing, having an inner lining cloth which is a wearable form composed of a fiber component, the fiber component is an insulating fiber cloth, and at least part of it has a conductive fiber thread, the arrangement of the conductive fiber thread is based on the meridians of the human to form a conductive contact area on the fiber component, and the conductive fiber thread has an electrical plug; a multifunctional composite module, which at least having optical, electrical, thermal and magnetic functions, arranged on the surface of the fiber component and electrically connected to the conductive contact area, and when the AI composite clothing is worn on the human body, the multifunctional composite module is relatively attached to at least one acupuncture point of the human body; the multifunctional composite module includes: a wire frame, which is made of copper as the main material, and is wire bonding with a plurality of metal wires on a flexible printed circuit; A plurality of light emitting diodes, including at least three-color LEDs of red (R), green (G), and blue (B), are connected in the middle of the wire frame to produce different light colors, then arranges a package above it; at least one sheet resistance, connected to the wire frame to generate heat; at least one inductance, connected to the wire frame to apply current to generate magnetism; at least a pair of electrode pads, connected to the wire frame and apply voltage to generate low frequency waves; a conductive rubber, arranged in an annular shape on the wire frame, and the package is exposed on the conductive rubber in the middle; at least one micro vibrator, arranged next to the multifunctional composite module and is electrically connected to the conductive contact area; an intelligent control device, mounted on a belt and has a liquid crystal panel and more than one electrical connection hole on its surface for connecting the electrical plug of the conductive fiber thread to control the multifunctional composite module and the micro vibrator, inside the intelligent control device are provided with a processor, an LED control circuit, a current control circuit, a voltage control circuit, a low frequency control circuit, a vibration control circuit, a first wireless transmission module and a battery for suppling the power required by the intelligent control device.

Also, the VR glasses have an iris recognition chip in the glasses frame.

Also, having a steering wheel in front of the seat.

Also, the bottom end of the calf member of the motion platform is connected to a crawler-type climbing wheel, the crawler-type climbing wheel includes a triangle frame, three movable wheels are symmetrically arranged on the triangle frame, the center of the triangle frame is connected to the outside of the bottom end of the calf member by a driving shaft, the driving shaft is driven by a motor and can drive three movable wheels and a crawler track to operate, thereby forming an electric stair climbing vehicle.

### BRIEF DESCRIPTION OF THE DRAWINGS

FIG. 1 is a perspective view of the motion platform of the present invention;

FIG. 2 is a side view of the motion platform of the present invention;

FIG. 3 is a front view of the motion platform of the present invention;

FIG. 4 is a schematic diagram illustrating a partial structure of the motion platform of the present invention;

FIG. 5 is a schematic diagram illustrating the operation of the partial structure of the motion platform of the present invention;

FIG. 6 is an exploded perspective view of the XYθ axis moving platform of the present invention;

FIG. 7 is an assembly perspective view of the XYθ axis moving platform of the present invention;

FIG. 8 is a perspective view of the motion platform combined with the XYθ axis moving platform of the present invention;

FIG. 9 is a schematic diagram illustrating the motion platform movement in X axis on the XYθ axis moving platform of the present invention;

FIG. 10 is a schematic diagram illustrating the motion platform movement in Y axis on the XYθ axis moving platform of the present invention;

FIG. 11 is a schematic diagram illustrating the motion platform rotation with θ degree on the XYθ axis moving platform of the present invention;

FIG. 12A is a perspective view of the smart helmet of the present invention;

FIG. 12B is a perspective view of the VR glasses of the present invention;

FIG. 12C is a schematic diagram illustrating the iris of human eye;

FIG. 13 is a schematic diagram illustrating the structure of the smart helmet and the VR glasses of the present invention;

FIG. 14A is a schematic diagram illustrating the application of the present invention;

FIG. 14B is a schematic diagram illustrating the application of the present invention;

FIG. 14C is a schematic diagram illustrating the application of the present invention;

FIG. 15 is a perspective view of the AI composite clothing of the present invention;

FIG. 16 is a perspective view of the lining cloth of the AI composite clothing of the present invention;

FIG. 17A is a perspective view of the multifunctional composite module combined with the fiber component of the present invention;

FIG. 17B is a side view of the multifunctional composite module combined with the fiber component of the present invention;

FIG. 17C is a sectional view of the multifunctional composite module combined with the fiber component of the present invention;

FIG. 17D is an exploded perspective view of the multifunctional composite module combined with the fiber component of the present invention;

FIG. 18 is a schematic diagram illustrating the structure of the multifunctional composite module combined with the fiber component of the present invention;

FIG. 19 is a perspective view of a preferred embodiment of the present invention;

FIG. 20 is a schematic diagram illustrating the crawler track of the preferred embodiment of the present invention;

FIG. 21 is a side view of the preferred embodiment of the present invention;

FIG. 22 is a schematic diagram illustrating the application of the preferred embodiment of the present invention;

FIG. 23 is a schematic diagram illustrating the application of the preferred embodiment of the present invention.

### DETAILED DESCRIPTION OF THE PREFERRED EMBODIMENT

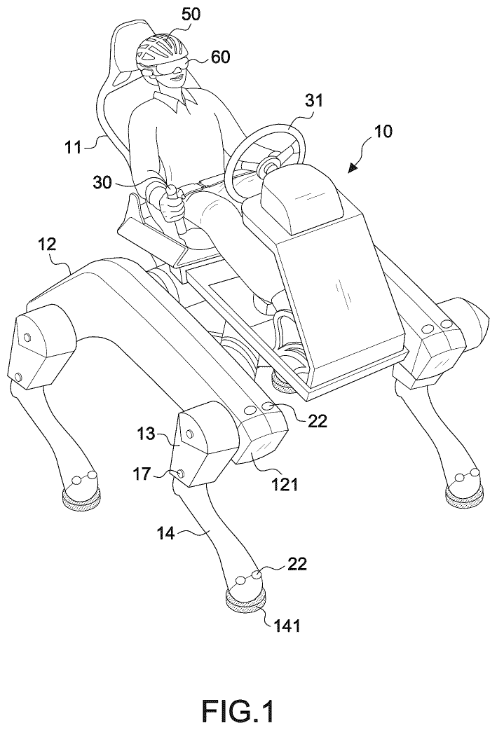

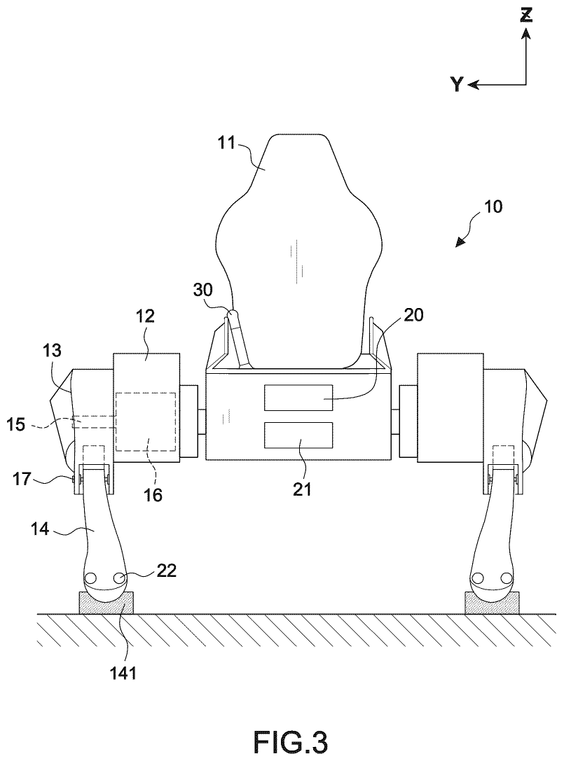

Referring to FIGS. 1~3, a preferred embodiment of a smart interactive composite device of the present invention, includes: a motion platform 10 with a seat 11 arranged on the motion platform 10, and both sides of the seat 11 are connected to two parallel and symmetrical support frames 12; the support frames 12 are provided with a lighting 121 at the front and rear ends, the lateral sides are respectively provided with a thigh member 13, and the bottom end of the thigh member 13 pivot to a calf member 14, wherein the upper end of the thigh member 13 pivot to the support frame 12 through a rotating shaft 15, and the rotating shaft 15 is driven by a motor 16 provided in the supporting frames 12, as FIG. 3 showing.

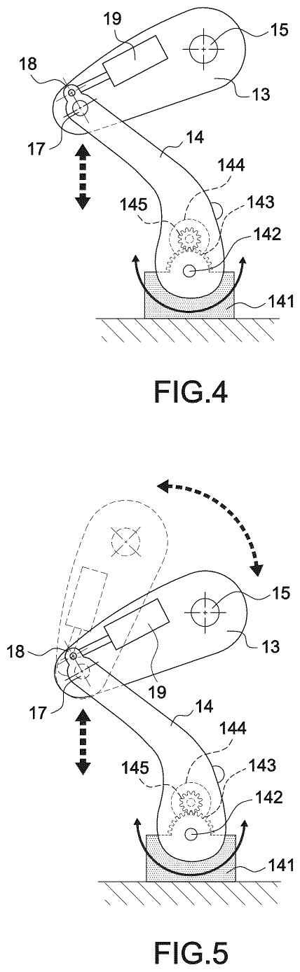

Referring to FIGS. 4~5, the thigh member 13 can swing forward or backward with the rotating shaft 15 as the axis; wherein the upper end of the calf member 14 pivot to the bottom end of the thigh member 13 with a pivot 17, the calf member 14 forms a convex lug 18 above the pivot 17, the convex lug 18 is driven by an oil cylinder 19 arranged inside the thigh member 13, making the calf member 14 able to swing forward or backward with the pivot 17 as the axis.

Moreover, four sets of connecting devices 141 are respectively arranged at the bottom of the calf members 14, so that it can be firmly contacted with the ground or connected to a platform. In this embodiment, the connecting devices 141 can be configured to be movable like a joint, but is not limited thereto. The connecting devices 141 are pivotally connected to the bottom end of the calf members 14 by a pivot 142, and the connecting devices 141 form a sector gear 143 above the pivot 142; moreover, a torque inching motor 144 is fixed relative to the sector gear 143 inside the calf members 14, using a gear 145 of the torque inching motor 144 to mesh with the sector gear 143, thereby forming a movable joint between the connecting devices 141 and the calf members 14, so the motion platform 10 has a more multi-dimensional and detailed action.

Referring to FIGS. 1~3, a plurality of radar sensors 22, arranged on the support frame 12, the thigh member 13 and the calf members 14, the radar sensor 22 is used to detect surrounding objects and movement changes of the motion platform 10.

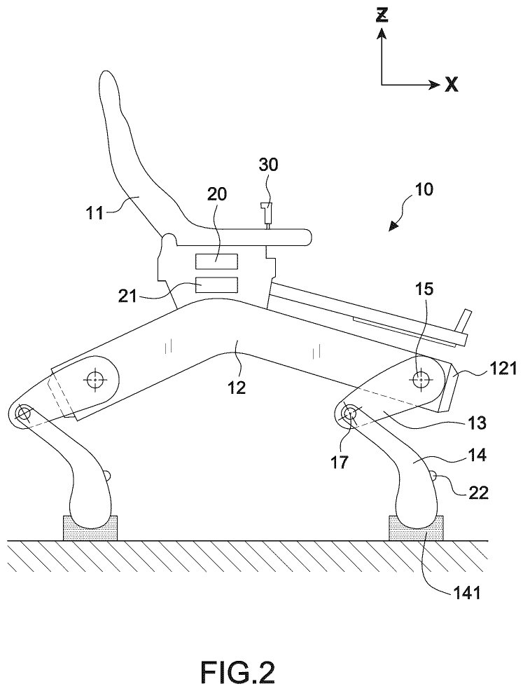

Referring to FIGS. 2~3, a controller 20, arranged on the seat 11, having a first wireless transmission module 21; a joystick 30, electrically connected to the controller 20 to control the respective movements of the motor 16 and oil cylinder 19 to make the motion platform 10 to lift and decline, move forward and backward, and tilt left and right; moreover, having a steering wheel 31 in front of the seat 11.

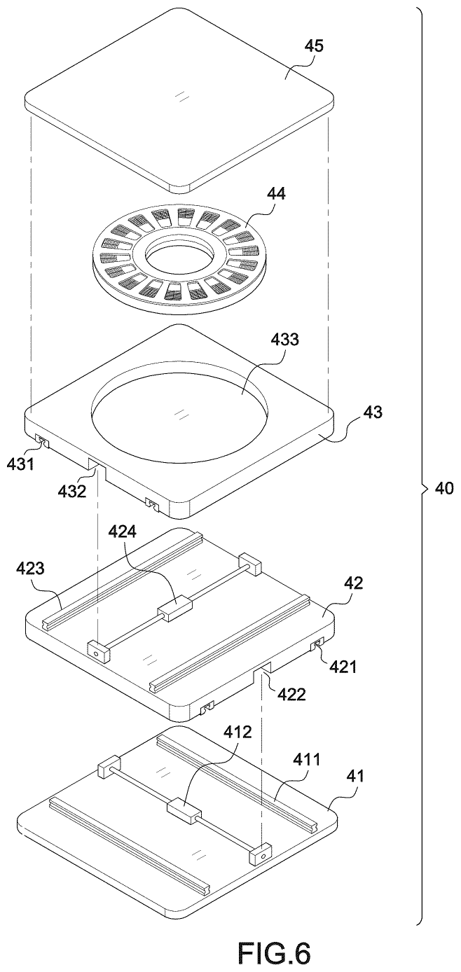

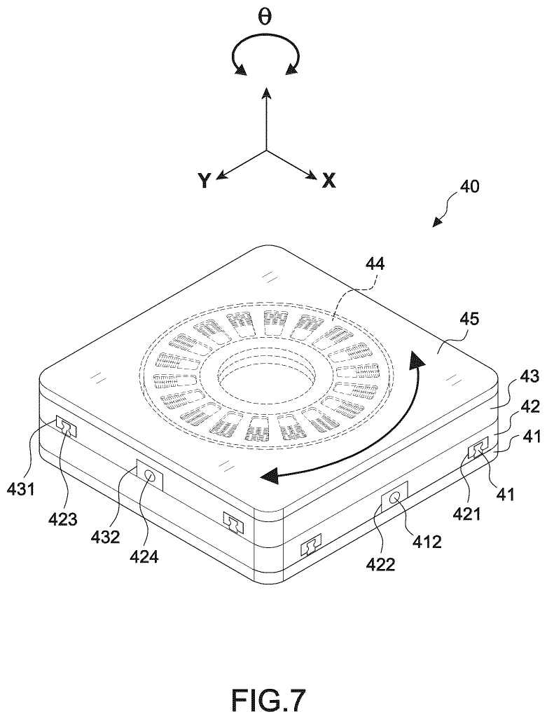

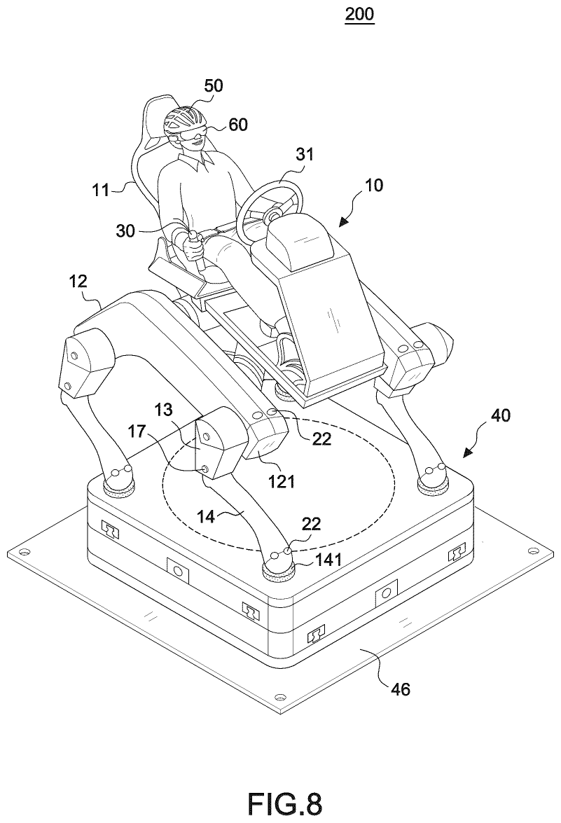

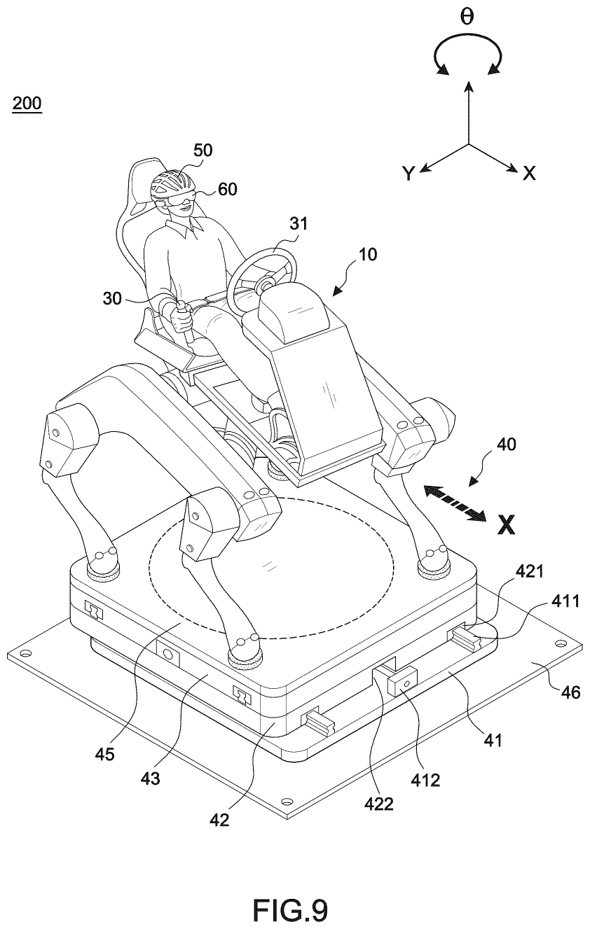

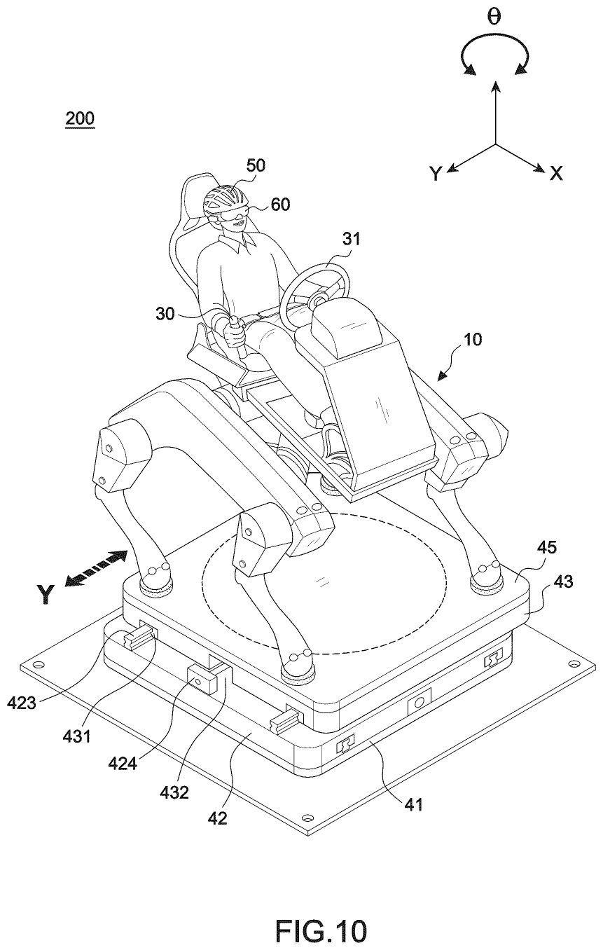

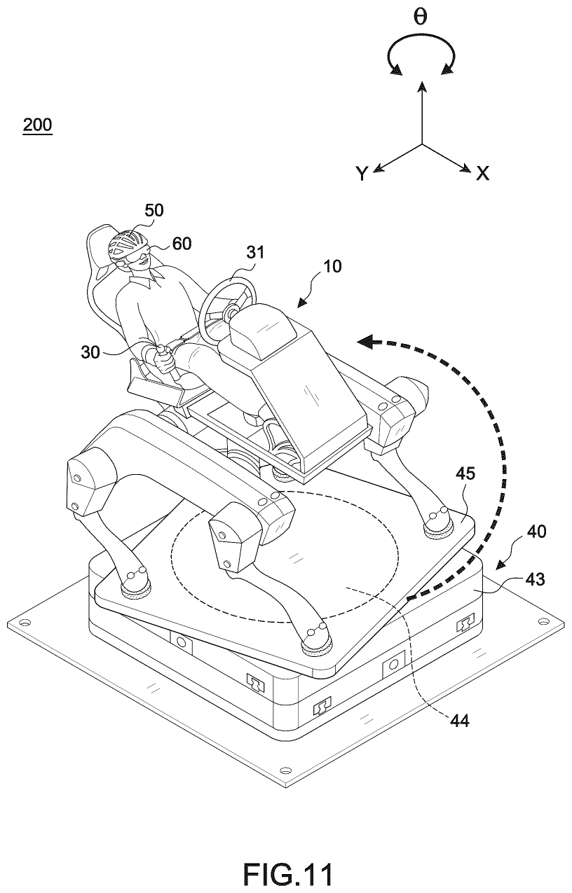

Referring to FIGS. 6~11, a XYθ axis moving platform 40, includes: a base seat 41, arranged with two parallel first tracks 411 and a first linear guide 412 longitudinally provided on the upper surface of the base seat 41; a longitudinal slide board 42, arranged on the base seat 41, and its bottom surface is provided with two parallel first slide grooves 421 relative to the first tracks 411, and is provided with a first groove 422 relative to the first linear guide 412 to be combined with the first linear guide 412 for driving the longitudinal slide board 42 to move forward and backward (in X axis); in addition, two parallel second tracks 423 and a second linear guide 424 are transversely provided on the upper surface of the longitudinal slide board 42.

A transverse slide board 43, arranged on the longitudinal slide board 42, and its bottom surface is provided with two parallel second slide grooves 431 relative to the second tracks 423, and is provided with a second groove 432 relative to the second linear guide 424 to be combined with the second linear guide 424 for driving the transverse slide board 43 to move left and right (in Y axis); in addition, and the upper surface of the transverse slide board 43 is provided with a circular groove 433; a disc type motor 44, arranged on the circular groove 433; a rotating board 45, combined to the disc type motor 44, and its bottom surface does not contact the upper surface of the transverse slide board 43, making the disc type motor 44 able to drive the rotating board 45 to rotate (θ);

With the above features, the top surface of the XYθ axis moving platform 40 allows the motion platform 10 to be placed on and is electrically connected to the controller 20 to form a multi-dimensional state in which the motion changes of the motion platform 10 are combined with the XYθ axis moving platform 40; In this embodiment, a positioning board 46 may be arranged at the bottom of the XYθ axis moving platform 40 for fixing on the ground.

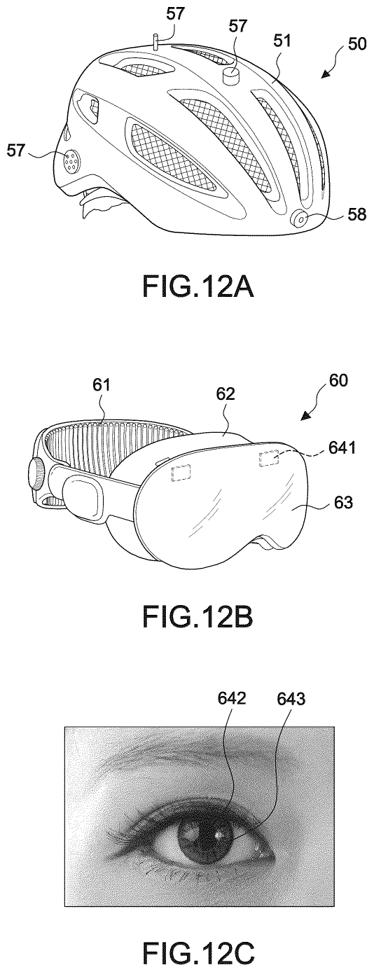

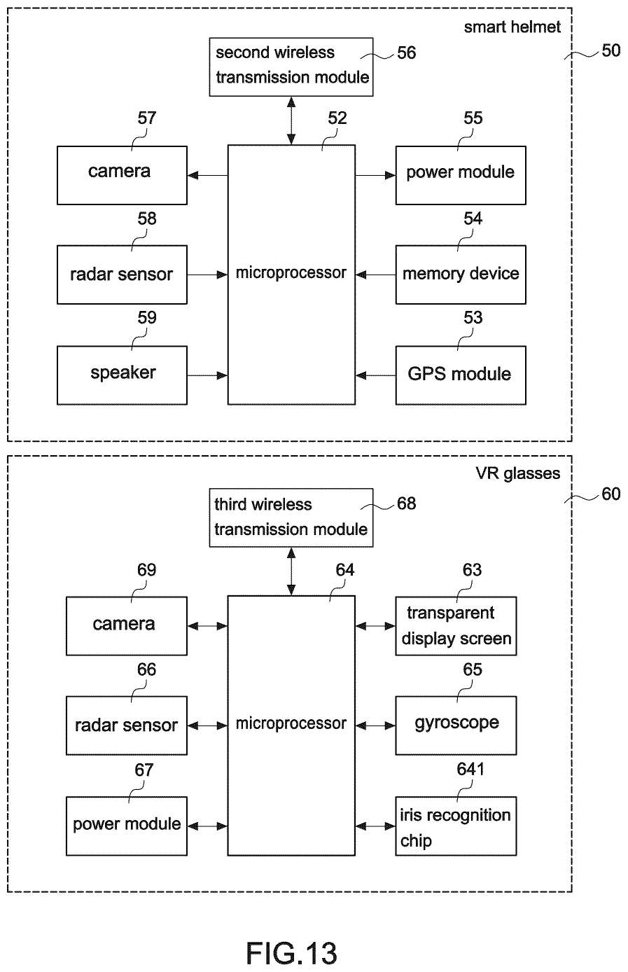

Referring to FIGS. 12A~12C, a smart helmet 50, having a case 51 with a microprocessor 52 inside, the microprocessor 52 is respectively electrically connected to a GPS module 53, a memory device 54, a power module 55 and a second wireless transmission module 56, and a camera 57 and a radar sensor 58 arranged on the case 51 and electrically connected to the microprocessor 52, and at least one speaker 59 is arranged on two sides of the case 51.

A VR glasses 60, having a headset 61, a glasses frame 62 connected to the headset 61, a transparent display screen 63 installed in the glasses frame 62, and a microprocessor 64 installed in the glasses frame 62, the microprocessor 64 is respectively electrically connected to a gyroscope 65, a memory device 66, a power module 67, a third wireless transmission module 68 and a camera 69; Currently, VR glasses have been widely used in electronic games. In this embodiment, the VR glasses 60 are mainly used to cooperate with the aforementioned smart helmet 50 for interaction. Referring to FIG. 12B, the VR glasses 60 have an iris recognition chip 641 in the glasses frame 62. Referring to FIG. 12C, since the iris 643 is a ring-shaped color tissue around the pupil 642, the basic structure of the eyeball is that the central black part is the pupil area, and the outer part is the iris area. Since it has rich and different texture patterns, it constitutes the basis of iris recognition; Therefore, iris recognition has the characteristics of uniqueness, stability, difficulty in forging, and liveness detection, and has an absolute advantage in security performance. Therefore, the present invention applies iris recognition to the VR glasses 60. However, the principle and structure of iris recognition are not the patent subject of the present invention and will not be described in detail.

Through the controller 20, making the first wireless transmission module 21 forms a communication connection with the second wireless transmission module 56 and the third wireless transmission module 68, so that the motion platform 10, the XYθ axis moving platform 40, the smart helmet 50 and the VR glasses 60 have an interactive relationship, forming a 4D immersive interactive game car 200, so as to achieve a smart interactive composite device.

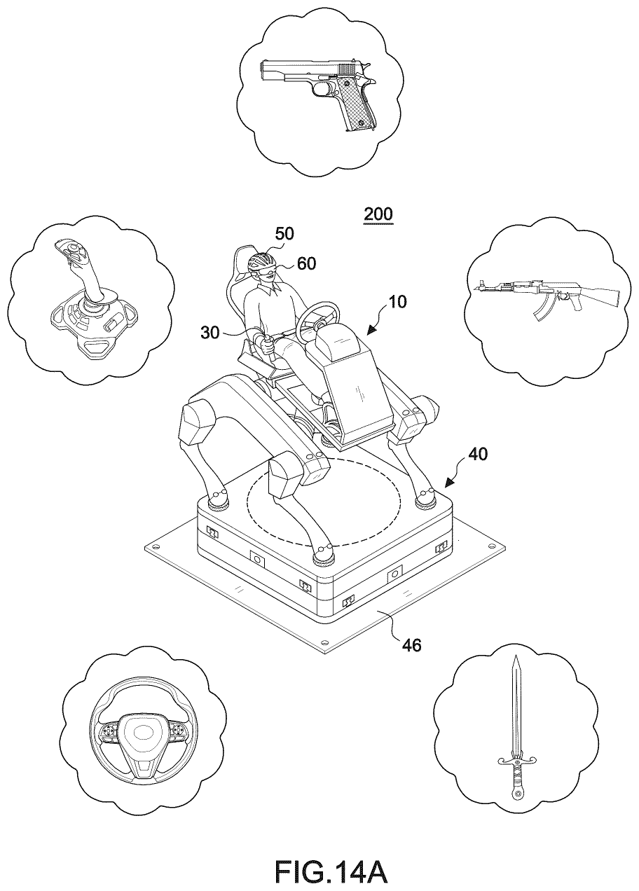

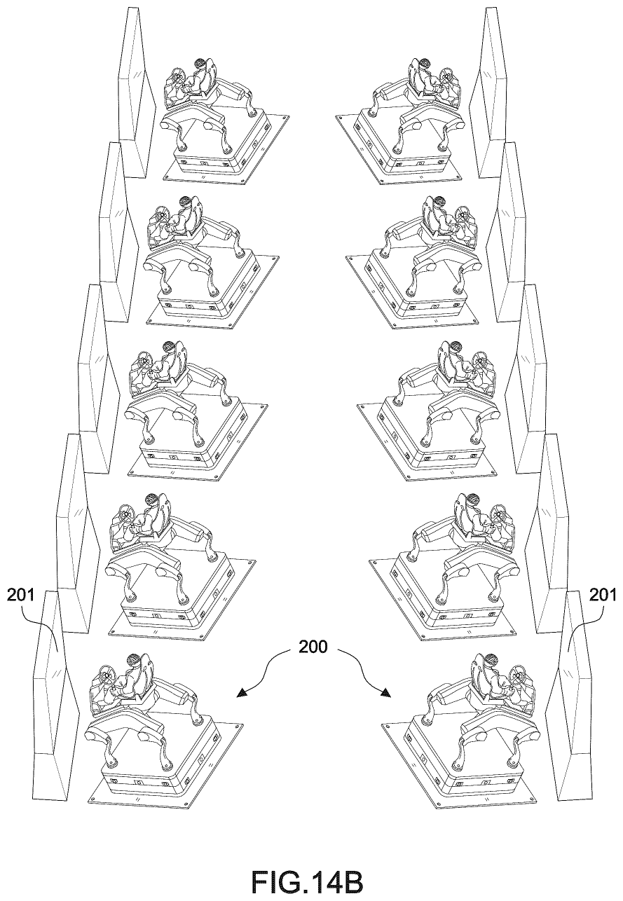

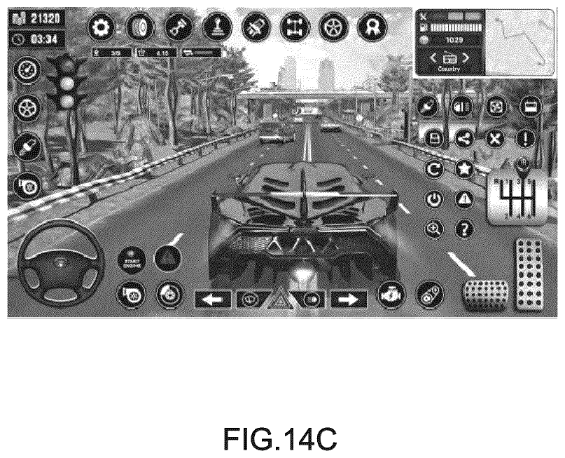

With the features above disclosed, the 4D immersive interactive game car 200 combined motion platform 10, the XYθ axis moving platform 40, the smart helmet 50 and the VR glasses 60 to allow users to experience the moving virtual reality environment, makes the game character vivid and distinctive, and allows players to obtain a deeper immersive experience and enhance the virtual reality, fun and entertainment of the game. Referring to FIG. 14A, illustrating the application of the present invention, the 4D immersive interactive game car 200 can be equipped with a gun controller, a steering wheel controller, a remote control, a knife controller, etc. So as to obtain vivid virtual reality experience.

Referring to FIG. 14B, illustrating the application of the present invention, the 4D immersive interactive game car 200 can be arranged at two sides, and connected with a television 201, so the other can see what game user is playing, as FIG. 14C is showing.

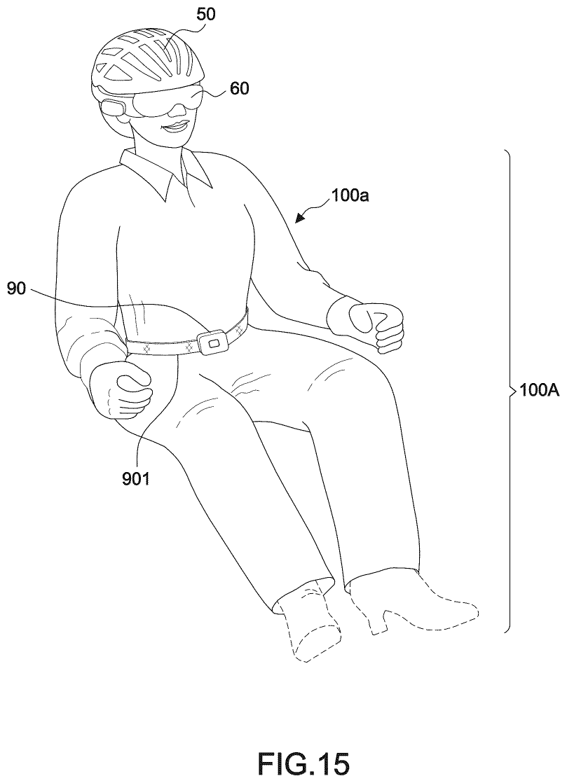

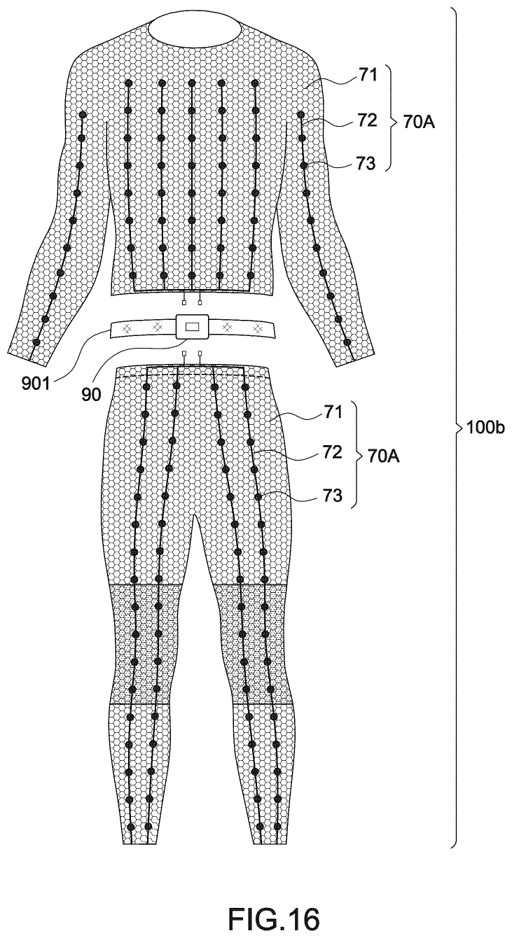

Referring to FIGS. 15~18, the present invention includes: an AI composite clothing 100A for user to wear, FIG. 15 shows the surface of the clothing 100a, FIG. 16 shows the AI composite clothing 100A having an inner lining cloth 100b which is a wearable form composed of a fiber component 70A, the fiber component 70A is an insulating fiber cloth 71, and at least part of it has a conductive fiber thread 72, the arrangement of the conductive fiber thread 72 is based on the meridians of the human to form a conductive contact area 73 on the fiber component 70A, and the conductive fiber thread 72 has an electrical plug 74; In this embodiment, the fiber component 70A is formed by interweaving the insulating fiber cloth 71 and the conductive fiber thread 72. That is, the conductive fiber thread 72 is woven into the insulating fiber cloth 71, which can be achieved by the existing smart fiber and textile technology, and the conductive contact area 73 is formed on the surface of the fiber component 70A by this technology. Furthermore, the conductive fiber thread 72 can be one or more conductive fiber thread 72 woven into the insulating fiber cloth 71. The conductive fiber thread 72 may include a metal fiber, a carbon fiber or an organic conductive fiber.

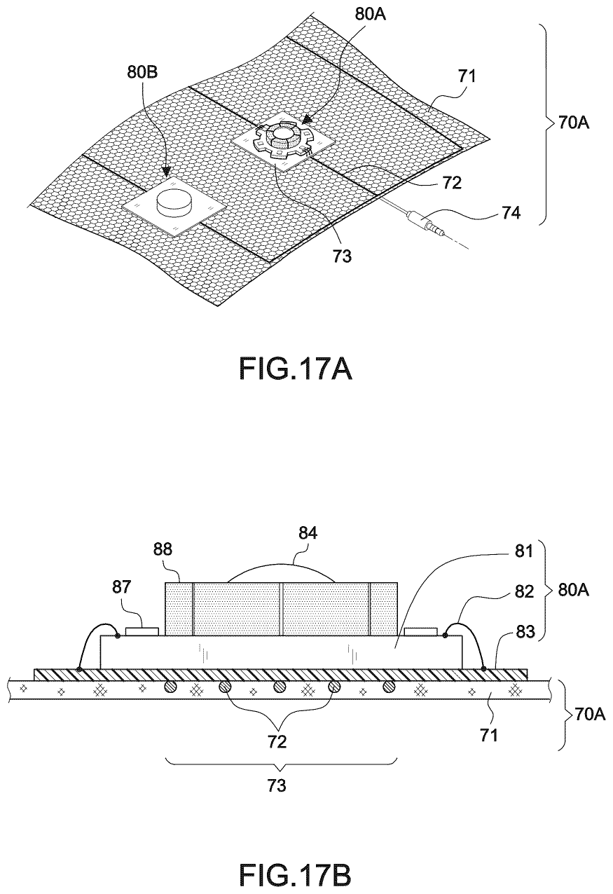

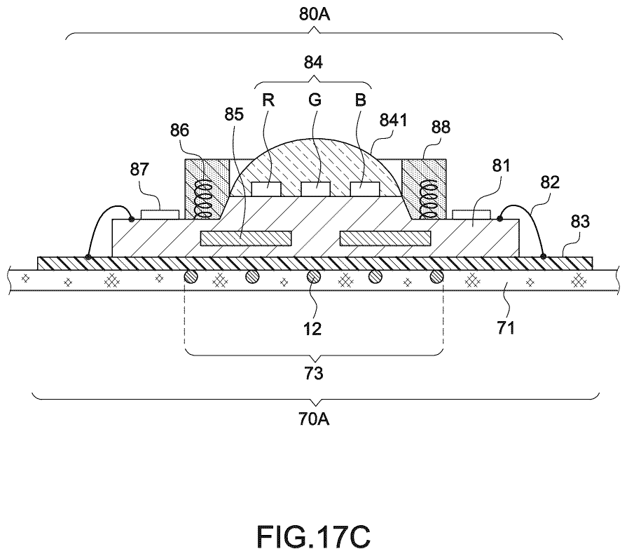

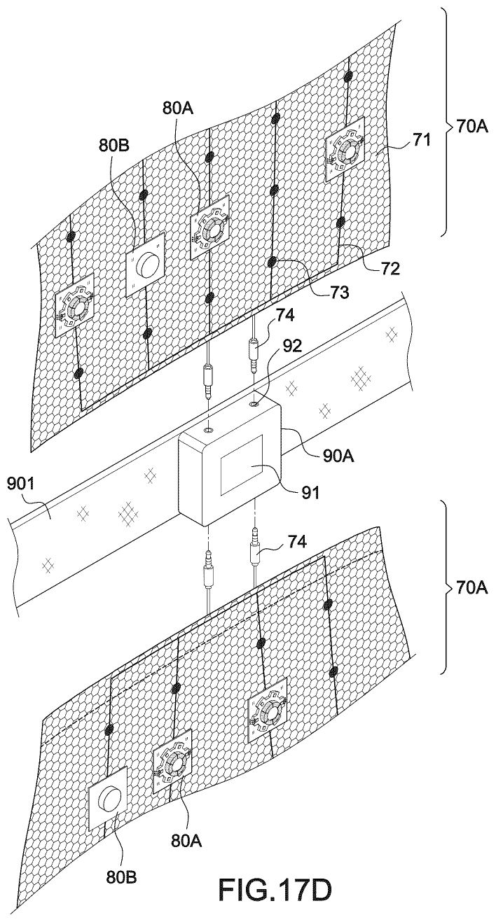

Referring to FIGS. 17A~17D, including a multifunctional composite module 80A, which at least having optical, electrical, thermal and magnetic functions, arranged on the surface of the fiber component 70A and electrically connected to the conductive contact area 73, and when the AI composite clothing 100A is worn on the human body, the multifunctional composite module 80A is relatively attached to at least one acupuncture point of the human body; the multifunctional composite module 80A includes: a wire frame 81, which is made of copper as the main material, and is wire bonding with a plurality of metal wires 82 on a flexible printed circuit 83; A plurality of light emitting diodes 84, including at least three-color LEDs of red (R), green (G), and blue (B), are connected in the middle of the wire frame 81 to produce different light colors, then arranges a package 841 above it; at least one sheet resistance 85, connected to the wire frame 81 to generate heat; at least one inductance 86, connected to the wire frame 81 to apply current to generate magnetism; at least a pair of electrode pads 87, connected to the wire frame 81 and apply voltage to generate low frequency waves; a conductive rubber 88, arranged in an annular shape on the wire frame 81, and the package 841 is exposed on the conductive rubber 88 in the middle; at least one micro vibrator 80B, arranged next to the multifunctional composite module 80A and is electrically connected to the conductive contact area 73.

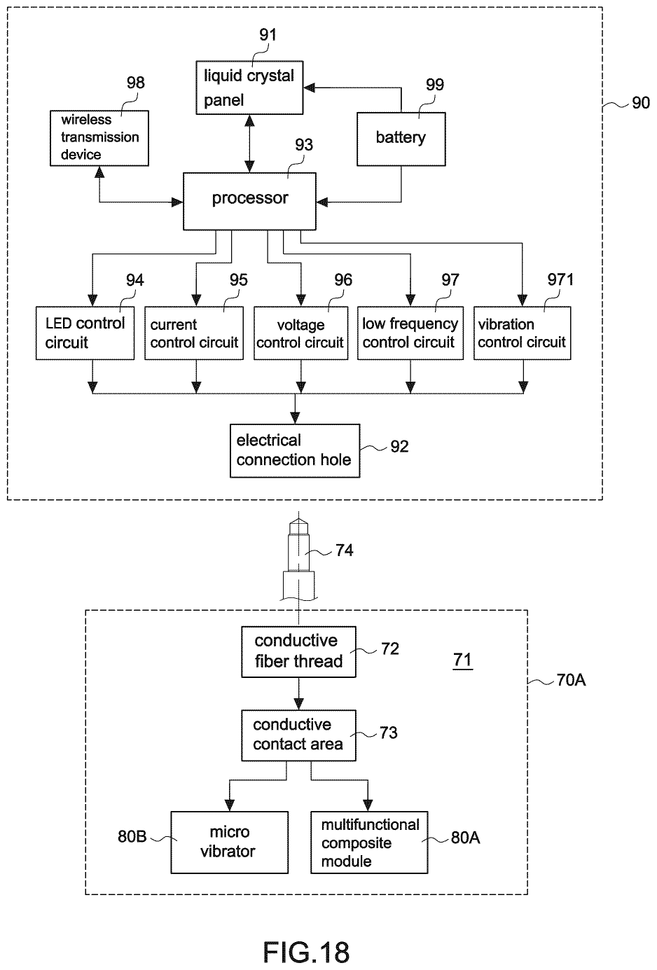

Referring to FIG. 17D, an intelligent control device 90, mounted on a belt 901 and has a liquid crystal panel 91 and more than one electrical connection hole 92 on its surface for connecting the electrical plug 74 of the fiber component 70A to control the multifunctional composite module 80A and the micro vibrator 80B; referring to FIG. 18, inside the intelligent control device 90 are provided with a processor 93, an LED control circuit 94, a current control circuit 95, a voltage control circuit 96, a low frequency control circuit 97, a vibration control circuit 971, a first wireless transmission module 98 and a battery 99 for suppling the power required by the intelligent control device 90, the multifunctional composite module 80A and the micro vibrator 80B.

In this embodiment, the light emitting diodes 84, in the multifunctional composite module 80A can be controlled by the LED control circuit 94 of the intelligent control device 90 to generate light of different colors or wavelength.

In this embodiment, the sheet resistance 85 of the multifunctional composite module 80A can be controlled by the current control circuit 95 of the intelligent control device 90 to generate heat.

In this embodiment, the inductance 86 of the multifunctional composite module 80A can be controlled by the current control circuit 95 of the intelligent control device 90 to generate magnetic field.

In this embodiment, the electrode pads 87 of the multifunctional composite module 80A can be controlled by the voltage control circuit 96 and the low frequency control circuit 97 of the intelligent control device 90 to generate low frequency waves. The micro vibrator 80B can be controlled by the vibration control circuit 971 to generate vibration.

With the features above disclosed, the 4D immersive interactive game car 200 is further combined with the AI composite clothing 100A to achieve a smart interactive composite device. That is, when the user puts on the AI composite clothing 100A, the smart helmet 50 and VR glasses 60, then sit on the motion platform 10, it allows users to obtain a better operating experience in a virtual reality motion environment, makes the game character vivid and distinctive, and allows players to obtain a deeper immersive experience and enhance the virtual reality, fun and entertainment of the game.

For example: The smart helmet 50 and VR glasses 60 can display game content images, and the smart helmet 50 is linked with the AI composite clothing 100A and the motion platform 10. When the user operates the motion platform 10, the user interacts with the game content displayed by the VR glasses 60, and the interaction also links to the AI composite clothing 100A; For example, if a character in a game is shot, the micro vibrator 80B of the AI composite clothing 100A will vibrate at the shot site, and the light emitting diode 24 of the multifunctional composite module 20A at the relative position will light up, allowing users (game players) to immerse themselves in the game. Another example, the soft ware is a racing game, 4D immersive interactive game car 200 will tilt, shake or move in response to the situation of the racing game. Referring to FIG. 14A, users can manipulate the virtual steering wheel by placing their hands on the physical joystick 30, or the steering wheel 31, or in front of the virtual steering wheel and rotating around the virtual steering wheel, so does the virtual joystick. In addition, users can also obtain various weapons such as swords, pistols, machine guns, etc., which will not be listed in detail. Therefore, when users view images through a virtual reality system, they can feel as if they are moving in the scene from a first-person perspective, gaining a deeper immersive experience and enhancing the virtual reality and fun of the game.

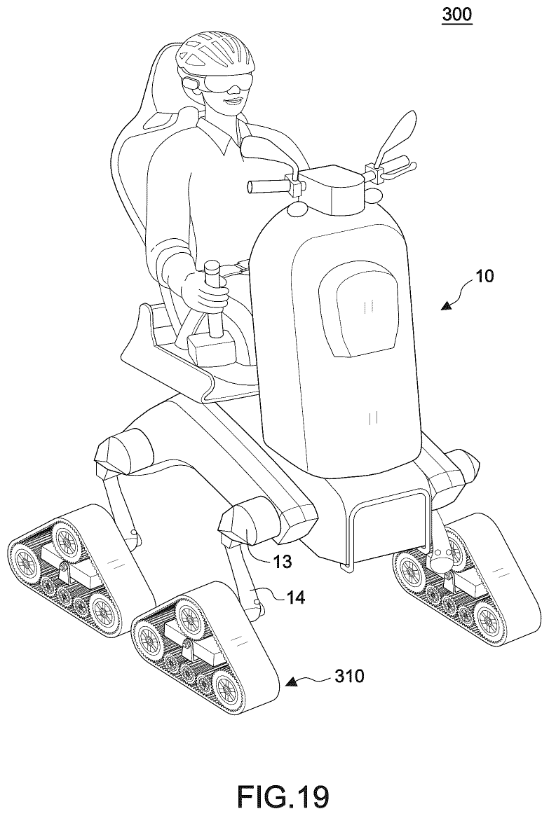

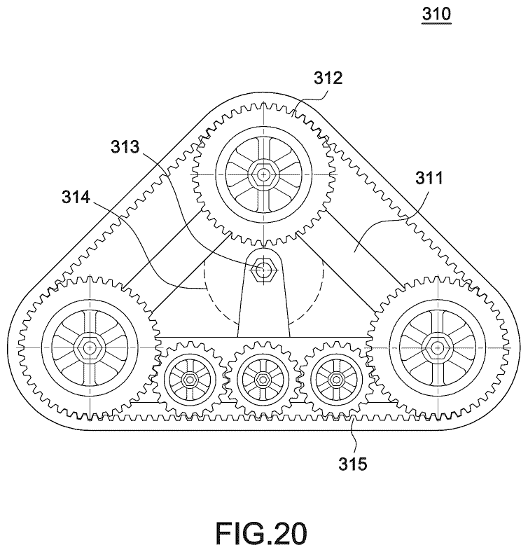

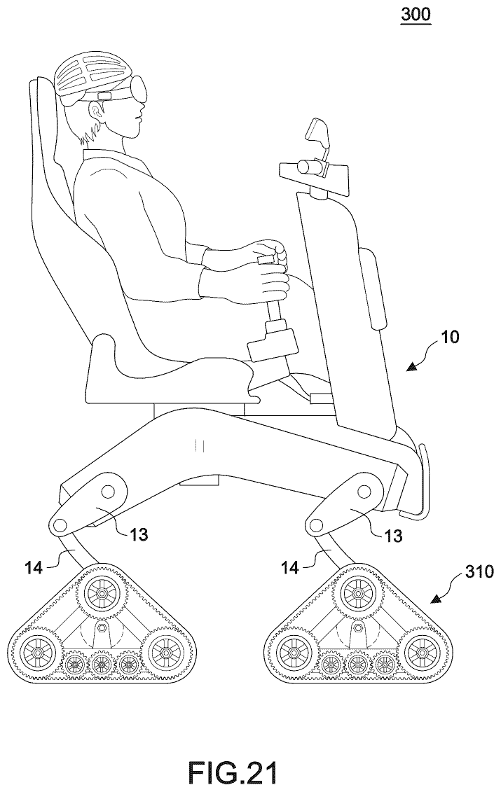

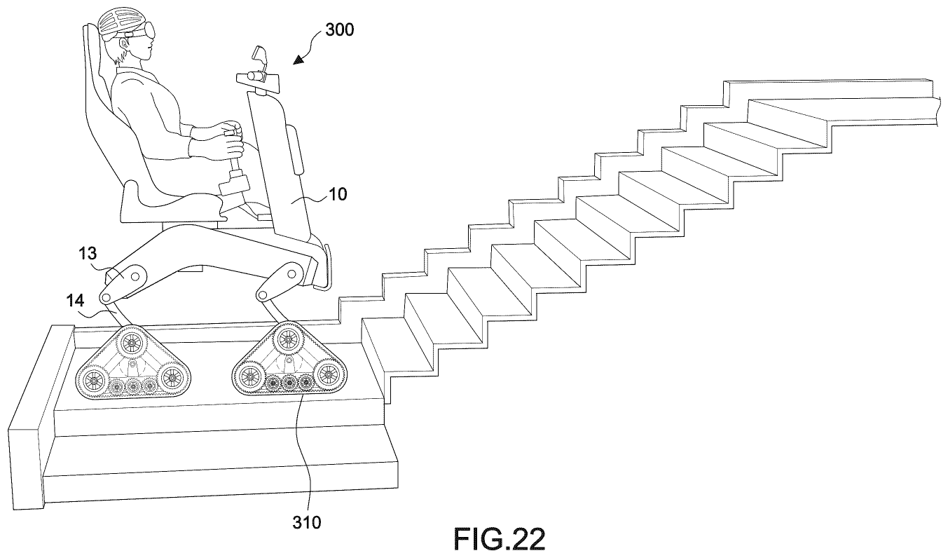

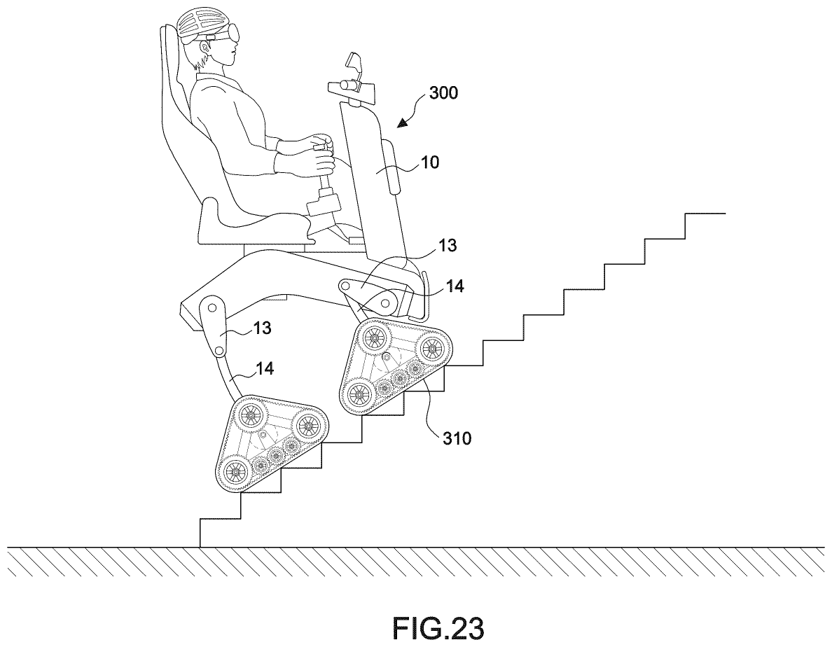

Referring to FIGS. 19~23, which shows another embodiment of the present invention, it utilizes the functions derived from the technical features of the motion platform 10 to form an electric stair climbing vehicle 300; the bottom end of the calf member 14 of the motion platform 10 is connected to a crawler-type climbing wheel 310, the crawler-type climbing wheel 310 includes a triangle frame 311, three movable wheels 312 are symmetrically arranged on the triangle frame 311, the center of the triangle frame 311 is connected to the outside of the bottom end of the calf member 14 by a driving shaft 313, the driving shaft 313 is driven by a motor 314 and can drive three movable wheels 312 and a crawler track 315 to operate. The present embodiment is not about the structure of the crawler-type climbing wheel 310, but about the technical feature that the thigh member 13 and the calf member 14 of the motion platform 10 can be retracted or extended to each other, and the plurality of radar sensors 22 detect the surrounding terrain and objects, and then automatically adjust the motion platform 10 in accordance with the height of the stairs so that the front and rear sides reach a balanced state and will not fall over.

With the features disclosed above, the effect of the present invention includes:

1. The present invention has a motion platform 10 combining on a XYθ axis moving platform 40, and further combining with a smart helmet 50 and VR glasses 60 to form a 4D immersive interactive game car 200, which achieves functions of “real vehicle simulation actions and vehicle tactile feedback simulation actions”, and allows users to obtain a better operating experience in a virtual reality motion environment, makes the game character vivid and distinctive, and allows players to obtain a deeper immersive experience and enhance the virtual reality, fun and entertainment of the game.

2. The present invention work together with the AI composite clothing 100A, when the user operates the motion platform 10, the user interacts with the game content displayed by the VR glasses 60, and the interaction also links to the AI composite clothing 100A; Let users (game players) immerse themselves in the game. Allow gamers to gain a deeper immersive experience and enhance the game's sense of virtual reality.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A smart interactive composite device, includes:
a). a motion platform with a seat arranged on the motion platform, and both sides of the seat are connected to two parallel and symmetrical support frames;
the support frames are provided with a lighting at the front and rear ends, the lateral sides are respectively provided with a thigh member, and the bottom end of the thigh member pivot to a calf member, wherein the upper end of the thigh member pivot to the support frame through a rotating shaft, and the rotating shaft is driven by a motor provided in the supporting frames, so that the thigh member can swing forward or backward with the rotating shaft as the axis; wherein the upper end of the calf member pivot to the bottom end of the thigh member with a pivot, the calf member forms a convex lug above the pivot, the convex lug is driven by an oil cylinder arranged inside the thigh member, making the calf member able to swing forward or backward with the pivot as the axis; accordingly, the thigh member and the calf members form a body similar to a four legs animal; four sets of connecting devices are respectively arranged at the bottom of the calf members;
a plurality of radar sensors, arranged on the support frame, the thigh member and the calf members;
a controller, arranged on the seat, having a first wireless transmission module;
a joystick, electrically connected to the controller to control the respective movements of the motor and oil cylinder to make the motion platform to lift and decline, move forward and backward, and tilt left and right;
b). a XYθ axis moving platform, includes
a base seat, arranged with two parallel first tracks and a first linear guide longitudinally provided on the upper surface of the base seat;
a longitudinal slide board, arranged on the base seat, and its bottom surface is provided with two parallel first slide grooves relative to the first tracks, and is provided with a first groove relative to the first linear guide to be combined with the first linear guide for driving the longitudinal slide board to move forward and backward (in X axis); in addition, two parallel second tracks and a second linear guide are transversely provided on the upper surface of the longitudinal slide board;
a transverse slide board, arranged on the longitudinal slide board, and its bottom surface is provided with two parallel second slide grooves relative to the second tracks, and is provided with a second groove relative to the second linear guide to be combined with the second linear guide for driving the transverse slide board to move left and right (in Y axis); in addition, and the upper surface of the transverse slide board is provided with a circular groove;
a disc type motor, arranged on the circular groove;
a rotating board, combined to the disc type motor, and its bottom surface does not contact the upper surface of the transverse slide board, making the disc type motor able to drive the rotating board to rotate (θ);
the top surface of the XYθ axis moving platform allows the motion platform to be placed on and is electrically connected to the controller to form a multi-dimensional state in which the motion changes of the motion platform are combined with the XYθ axis moving platform;
c). a smart helmet, having a case with a microprocessor inside, the microprocessor is respectively electrically connected to a GPS module, a memory device, a power module and a second wireless transmission module, and a camera and a radar sensor arranged on the case and electrically connected to the microprocessor, and at least one speaker is arranged on two sides of the case;
d). a VR glasses, having a headset, a glasses frame connected to the headset, a transparent display screen installed in the glasses frame, and a microprocessor installed in the glasses frame, the microprocessor is respectively electrically connected to a gyroscope, a memory device, a power module, a third wireless transmission module and a camera; and
through the controller, making the first wireless transmission module forms a communication connection with the second wireless transmission module and the third wireless transmission module, so that the motion platform, the XYθ axis moving platform, the smart helmet and the VR glasses have an interactive relationship, forming a 4D immersive interactive game car.

2. The smart interactive composite device as claimed in claim 1, wherein further includes: an AI composite clothing, having an inner lining cloth which is a wearable form composed of a fiber component, the fiber component is an insulating fiber cloth, and at least part of it has a conductive fiber thread, the arrangement of the conductive fiber thread is based on the meridians of the human to form a conductive contact area on the fiber component, and the conductive fiber thread has an electrical plug; a multifunctional composite module, which at least having optical, electrical, thermal and magnetic functions, arranged on the surface of the fiber component and electrically connected to the conductive contact area, and when the AI composite clothing is worn on the human body, the multifunctional composite module is relatively attached to at least one acupuncture point of the human body; the multifunctional composite module includes: a wire frame, which is made of copper as the main material, and is wire bonding with a plurality of metal wires on a flexible printed circuit; A plurality of light emitting diodes, including at least three-color LEDs of red (R), green (G), and blue (B), are connected in the middle of the wire frame to produce different light colors, then arranges a package above it; at least one sheet resistance, connected to the wire frame to generate heat; at least one inductance, connected to the wire frame to apply current to generate magnetism; at least a pair of electrode pads, connected to the wire frame and apply voltage to generate low frequency waves; a conductive rubber, arranged in an annular shape on the wire frame, and the package is exposed on the conductive rubber in the middle; at least one micro vibrator, arranged next to the multifunctional composite module and is electrically connected to the conductive contact area;
an intelligent control device, mounted on a belt and has a liquid crystal panel and more than one electrical connection hole on its surface for connecting the electrical plug of the conductive fiber thread to control the multifunctional composite module and the micro vibrator, inside the intelligent control device are provided with a processor, an LED control circuit, a current control circuit, a voltage control circuit, a low frequency control circuit, a vibration control circuit, a first wireless transmission module and a battery for suppling the power required by the intelligent control device.

3. The smart interactive composite device as claimed in claim 1, wherein the VR glasses have an iris recognition chip in the glasses frame.

4. The smart interactive composite device as claimed in claim 1, wherein having a steering wheel in front of the seat.

5. The smart interactive composite device as claimed in claim 1, wherein the bottom end of the calf member of the motion platform is connected to a crawler-type climbing wheel, the crawler-type climbing wheel includes a triangle frame, three movable wheels are symmetrically arranged on the triangle frame, the center of the triangle frame is connected to the outside of the bottom end of the calf member by a driving shaft, the driving shaft is driven by a motor and can drive three movable wheels and a crawler track to operate, thereby forming an electric stair climbing vehicle.
